(19) United States
(12) Patent Application Publication
(10) Pub. No.: US 2007/0111187 A1
(43) Pub. Date: May 17, 2007

(54) Multiple-choice question database enhancement

(76) Inventor: Stu Rasmussen, Silverton, OR (US)

Correspondence Address: Stu Rasmussen, P.O. Box 1130, Mt. Angel, OR, 97381-1130, US

(21) Appl. No.: 11/586,183

(22) Filed: Oct. 24, 2006

Related U.S. Application Data
(60) Provisional application No. 60/730,157, filed on Oct. 24, 2005.

(51) Int. Cl. G09B 3/00

(52) U.S. Cl. 434/350

(57) ABSTRACT

A method of generating and formatting questions for multiple choice trivia quizzes or electronic games which re-uses and re-formats a group of paired textual or arithmetic question data to give a larger variety of questions than existing methods of doing same.

### CROSS REFERENCE TO RELATED APPLICATIONS

This application is entitled to the benefit of Provisional Patent Application Ser. No. 60/730,157 filed 2005-10-24.

### BACKGROUND-FIELD OF THE INVENTION

This invention relates generally to electronic games using multiple-choice questions

### BACKGROUND-DESCRIPTION OF PRIOR ART

There are hundreds of patents of various kinds of games, board games, video games, trivia games and other related inventions, but our search revealed none that utilized any method of expanding and enhancing the question database as described in the current invention. The question data for existing games we found was in the equivalent format of Question, Correct Answer, and a number (2-5) of incorrect or bogus answers. Some typical game systems using multiple choice questions in this manner are represented in 6,890,181 by Warneke, et al,; 6,988,096 by Gupta et al.; 6,996,413 by Inselberg and 7,033,182 by Anand. These and many others use pre-formatted questions exclusively.

### SUMMARY

I have invented a “Multiple Choice Question Database Enhancement ” method for use in skill—or knowledge-based game systems that use multiple-choice questions. These are games of the type that may be either home amusement or coin operated amusement game systems as my question database enhancement invention is applicable to a variety of systems.

Objects and Advantages

The objects of my invention are to provide an easy and economical means of generating large numbers of knowledge questions for trivia-type games and providing a means of re-using data by reconfiguring the manner in which the question data is displayed. Other similar and dissimilar uses of the invention will be readily apparent to a person with skill in the art once the operation of the invention is fully described.

One advantage of my invention over existing methods is economy of question generation. Typically, a multiple choice question game system provides the player with a question and a number of possible answers, only one of which is the correct answer. For example, commercially available databases of trivia questions are provided in the general format:
a) Question
b) Correct Answer
c) Incorrect Answer 1
d) Incorrect Answer 2
e) Incorrect Answer 3
f) . . . etc.

Such questions are currently available commercially from a number of vendors. The cost for this data is on a per question basis. The limitation is that each question group provides only one correct question/answer for the purchased cost of the question.

My invention significantly reduces the cost of database generation and improves the user/player experience in a multiple-choice game play situation. Each question group created and displayed using my invention may be used multiple times without the duplication being apparent to the game player. The game player receives a more challenging game experience because the re-use of question data in a reconfigured form is more thought provoking and entertaining.

My invention, in the first of its configurations, re-casts the question format into:

Group A Group B

a) Question 1: Answer 1
b) Question 2: Answer 2
c) Question 3: Answer 3
d) Question 4: Answer 4:
e) etc. . . .
   and in a second configuration:
   Group A Group B
a) Phrase A1: Phrase B1
b) Phrase A2: Phrase B2
c) Phrase A3: Phrase B3
d) Phrase A4: Phrase B4
e) etc. . . .

These questions are editorially formatted is a specific way as described below:

The questions are formulated in a 2×N matrix group of questions and answers.
Question 1: Answer 1
Question 2: Answer 2
Question 3: Answer 3
Question 4: Answer 4
Question 5: Answer 5
etc.
   or, more accurately, two sets of ‘phrases’, each of which matches uniquely with its counterpart in the other group:
Phrase 1A: Phrase 1B
Phrase 2A: Phrase 2B
Phrase 3A: Phrase 3B
Phrase 4A: Phrase 4B
Phrase 5A: Phrase 5B, Etc.,

Each “Question” has one and only one “correct” answer in the matrix.

For Example:

Category: Geography

| | |
|---|---|
| Capital of Oregon: | Salem |
| Capital of Washington: | Olympia |
| Capital of California: | Sacramento |
| Capital of Nevada: | Carson City |
| Capital of New York: | Albany |

The game software algorithm selects one Phrase from one group and selects a number of Phrases from other group in the matrix. The software occasionally may not select the correct matching answer to display, and provides a ‘None of the Above” selection choice to the player, as shown below:
Capital of California?
A:Salem
B:Olympia
C:Sacramento
D:Albany
X:None of the Above

If the correct answer to the question is not among those selected, the correct reply must be ‘None of the Above”. For Example:
Capital of Nevada?
A:Salem
B:Olympia
C:Sacramento
D:Albany
X:None of the Above

When the questions groups are authored, there must be no ambiguity in the Question/Answer pairs.

For example, the following group is NOT ACCEPTABLE:

Category: Oregon Cities

| | |
|---|---|
| State Capital: | Salem |
| Largest City: | Portland |
| University of Oregon: | Eugene |
| Coastal Resort: | Lincoln City |
| High Desert: | Bend |

This is not acceptable because if our random selection is:
Largest City in Oregon?
A:Salem
B:Eugene
C:Lincoln City
D:Bend
X:None of the Above

it could be argued that either Eugene or Bend is the largest city in the group presented, but the expected CORRECT answer should be “None of the Above”.

This is only a sampling of how the questions could go wrong. Any reference to ‘best’, “longest”,“tallest”,“most”,etc would be unacceptable due to possible question/answer ambiguity after a random selection of answers. When a group is created, the author must mentally try all possible combinations to be sure everything works properly.

An additional enhancement which improves the yield of questions is that the question groups are bi-directionally symmetrical: The game software may select either one phrase from Group A and some number greater than one from Group B OR one phrase from Group B and some number greater than one from Group A.

### DRAWING FIGURES

No Drawings are included in this application

### REFERENCE NUMERALS IN DRAWINGS

None

### DESCRIPTION

An embodiment of this invention is demonstrated in the following software code snippet. Although a particular code algorithm is enumerated here, one skilled in the craft could describe and configure other code to accomplish the same process—The nature of the invention is in the configuration and manipulation of the input phrases, not just the exact method shown here. This snippet demonstrates the basic method to transform a ‘raw question group’ sample of 2×5 Phrases and formats it as a displayable entry during game play: The comments included in the code snippet document the operation of the invention.

// start of sample code using 2×5 matrix
int Format2×5Question(void)
{
// take raw question data, format as array of 6 string pointers with
letters ′A′, B’... etc added to front to make ready for display

| | |
|---|---|
| int ab=0; | // input selector for a/4b or 4a/b |
| int ae=0; | // input selector for which of 5 |

| | |
|---|---|
| int count=0; | // utility |

int answer=0;
//clear the output array:
for (ae=0;ae<6;ae++)
{out[ae]=NULL;}
// load the input array with pointers to raw question strings in
// raw_question_data
for (ae=0;ae<6;ae++)

{

in[ae][0]=&(raw_question_data.in[ae][0][0]);
in[ae][1]=&(raw_question_data.in[ae][1][0]);

| } | |
|---|---|
| ab=rand( ) % 2; | // decide if this is an a/4b or 4a/b format |
| ae=rand( ) % 5; | // now pick a question from the list |

// note that input string pointer format is in[ae][ab]

| | |
|---|---|
| out[0]=in[ae][ab]; | // select the question here |
| answer = (rand( ) %5)+1; | // put answer position |

// into range 1-5

// note that position 5 is ′BOGUS -

// (None of the Above) and not shown
// invert ab now to return answer for question or question for answer

if (ab==1) ab=0; else ab=1;

| out[answer] = in[ae][ab]; | |
|---|---|
| in[ae][ab]=NULL; | // mark as used so no repeats |

// now randomly assign the wrong answers
// to the rest of the output matrix
int err_count=0;

for (count=1; count <6; count++)
{

while (out[count] == NULL)
{

err_count++;
if (err_count>300)
{

err_count = 1000;

| } | |
|---|---|
| ae=rand( ) %5; | // values 0-4 |

| if (in[ae][ab] != NULL) | |
|---|---|
| {out[count]=in[ae][ab]; // stuff value into output | |
| in[ae][ab]=NULL; | // mark as used |
| } // end if | |
| } // end while | |
| } // end for | |

// now we have pointers into raw_data in in[ ],
// time to format the display strings

| | |
|---|---|
| sprintf (&(out_strings[0][0]),″%s\0″,out[0]); | // do the answer |

// first, no ABCD

for (ae=1; ae<5; ae++)
sprintf (&(out_strings[ae][0]),″%c: %s\0″, (′A′−1+ae),out[ae]);
// A-D answers

// Answer not shown - needed if BOGUS is correct match:

| sprintf (&(out_strings[ae][0]),″%c: %s\0″,(′X′),out[ae]); | |
|---|---|
| return answer−1; | // re-scale for 0-4 for button time array |

}

### Alternative Embodiments

There are various possibilities for different software procedures to accomplish the same purpose as described above, thus the scope of the invention should be determined by the appended claims and their legal equivalents rather than by the examples given.

What is claimed is:

1: A Multiple Choice Question Database Enhancement which is a new and novel method of creating one or more unique multiple choice questions, for use in a trivia game or similar device, from a single data set consisting of two or more text or arithmetic phrase pairs, said method consisting of the following components:
An editorially created group of N phrase pairs, where N is any number greater than 1 and each phrase pair Phrase_A[X}:Phrase_B[X] in the group represent a “question phrase”: “answer phrase” relationship and within the group of N phrase pairs no ambiguity exists between unmatched phrase pair components, and
A software or firmware algorithm which uses the above described text or arithmetic phrase pairs group as a source and creates an output matrix or array, in a manner suitable for use in a game display system, by performing the following steps: Randomly selecting one of the phrase pairs in the input group as the ‘correct’ question:answer and placing two pointers (or, in a less efficient embodiment, copying the text strings verbatim) to the components in the answer output matrix, with the ‘Phrase_A’ pointer being placed in the ‘question’ position and its ‘Phrase_B’ matching value pointer being place randomly in any of the ‘answer’ positions of the output matrix.
The remaining ‘answer’ pointer positions in the output array are then randomly filled with pointers to any of the other correspondingly positioned answer phrases ins such a way that all the output array answer positions are filled with pointers to unique answer phrases from the input matrix group.
The algorithm then returns the filled output array matrix and the index of the correct answer to the calling game program.

2: A method of creating one or more unique multiple choice questions as described in claim 1 which randomly reverses the question/answer placement position in the output matrix, thereby providing twice as many multiple choice output questions from the same array of input phrase pairs as the unidirectional method of claim 1.

3: A method of creating one or more unique multiple choice questions as described in claim 1 or claim 2 which randomly places the correct answer pointer in a position which is not utilized by the game display and thereby makes the correct answer “None of the Above”, thereby providing two times the multiple choice output questions as the bi-directional method of claim 2.
